(19) United States
(12) Patent Application Publication
(10) Pub. No.: US 2025/0104457 A1
(43) Pub. Date: Mar. 27, 2025

(54) A SYSTEM AND METHOD FOR VISUAL TEXT TRANSFORMATION

(71) Applicant: L&T TECHNOLOGY SERVICES LIMITED, Chennai (IN)

(72) Inventors: MADHUSUDAN SINGH, Bangalore (IN); SHYAMAL PARIKH, Vadodara (IN); SUDHIR BHADAURIA, Ahmedabad (IN); MEET PATEL, Navsari (IN); TRIPTESH MALLICK, Bankura (IN)

(21) Appl. No.: 18/393,716

(22) PCT Filed: Nov. 25, 2021
(86) PCT No.: PCT/IB2021/060976

§ 371 Date: Dec. 22, 2023

(51) Int. Cl. G06V 30/148; G06T 11/00; G06V 20/40; G06V 20/62; G06V 30/18; G06V 30/19

(52) U.S. Cl. CPC G06V 30/15; G06T 11/001; G06V 20/46; G06V 20/62; G06V 30/1801; G06V 30/19107; G06V 30/19173

(57) ABSTRACT

A method and system for extracting text from a video stream is disclosed. The method may include determining at least one visual text region in each image of a plurality of images. The at least one visual text region may include a plurality of text characters and determining the at least one visual text region is based on analysis of one of lines and curves associated with each of the plurality of text characters, blob associated with the plurality of text characters along an axis, distribution of the plurality of text characters along a major axis, and a common attribute associated with the plurality of text characters. The method may further include segmenting the plurality of text characters from a background, and inpainting each of the plurality of text characters with a predefined color.

### TECHNICAL FIELD

This disclosure relates generally to image or video processing, and more particularly to a method and a system for extracting text from an image or a video stream.

### BACKGROUND OF THE INVENTION

Videos like movies, news videos, commercials, and television programs may sometime contain textual information that can be informative and useful to a viewer. However, the viewer may not have options for extracting the text, other than manually writing down the text.

Some text extraction applications can be used for detecting and extracting text present in the video frames. These image or video processing applications may be used in relation to motion pictures for digitization of credit scenes, subtitle verification, media library metadata tagging, and the like. For example, text from natural scenes that are captured in video frames may be identified using any conventional histogram of oriented gradients (HOG) feature extraction-based techniques, and the text may further be segmented using hierarchical clustering algorithms.

However, the hierarchical clustering algorithms may be inefficient because of sensitivity to divergence and high computational cost. Further, the existing techniques for detecting text in videos of natural scenes may focus on characters of the text instead of a background noise removal. As a result, such techniques may be computationally expensive and may iterate multiple times, thereby increasing memory requirements of the associated systems.

Accordingly, there is a need for a computationally efficient and accurate text detection and segmentation solution.

### SUMMARY OF THE INVENTION

In an embodiment, a method of extracting text from a video stream is disclosed. The method may include determining at least one visual text region in each image of a plurality of images. The video stream may include the plurality of images in sequential order. The at least one visual text region may include a plurality of text characters. The method may further include determining the at least one visual text region. The at least one visual text region may be determined based on analysis of one of lines and curves associated with each of the plurality of text characters, a blob associated with the plurality of text characters along an axis, distribution of the plurality of text characters along a major axis (i.e. Horizontal axis or Vertical axis), and a common attribute associated with the plurality of text characters. The method may further include segmenting the plurality of text characters within the at least one visual text region from a background associated with the at least one visual text region. The method may further include inpainting each of the plurality of text characters with a predefined color.

In another embodiment, a system for extracting text from a video stream is disclosed. The system may a processor and a memory which stores a plurality of instructions. The plurality of instructions, upon execution by the processor, may cause the processor to determine at least one visual text region in each image of a plurality of images. The video stream may include the plurality of images in sequential order. The at least one visual text region may include a plurality of text characters. Determining the at least one visual text region may be based on analysis of one of: lines and curves associated with each of the plurality of text characters of the at least one visual text region, a blob associated with the plurality of text characters along an axis, distribution of the plurality of text characters along a major axis (i.e. Horizontal axis or Vertical axis), and a common attribute associated with the plurality of text characters. The plurality of instructions, upon execution by the processor, may cause the processor to segment the plurality of text characters within the at least one visual text region from a background associated with the at least one visual text region, and upon segmenting, inpaint each of the plurality of text characters with a predefined color.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary computing system that may be employed to implement processing functionality for various embodiments.

FIG. 2 is a functional block diagram of a text extraction device for extracting text from a video stream, in accordance with an embodiment of the present disclosure.

FIGS. 3A-3C are snapshots of example video frames comprising text, in accordance with an embodiment.

FIG. 4 illustrates a process of extracting text from an example video frame of a video stream, in accordance with an embodiment of the present disclosure.

FIG. 5 is a flowchart of a method of extracting text from a video stream, in accordance with an embodiment of the present disclosure.

FIG. 6 is a flowchart of a method of analyzing lines and curves associated with each of the plurality of text characters of at least one possible visual text region, in accordance with an embodiment. and

FIG. 7 is a flowchart of a method of segmenting a plurality of text characters within at least one visual text region from a background associated with the at least one visual text region, in accordance with an embodiment.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed.

It should be noted that the textual information is assumed to include text characters on a background of a high contrasting color. It is further assumed that the text may possess one or more special features, for example properly shaped edges and corners (as the construction of script is majorly using lines and curves), text blobs (the text characters are stable connected components and distributed with respect to eight major geographical axes, i.e. the axes aligned with geographical East, West, South, North, North-East, North-West, South-East, and South-West direction), axial uniformity (text is homogenously distributed along a major axis), and that the text characters associated with each other may be written altogether.

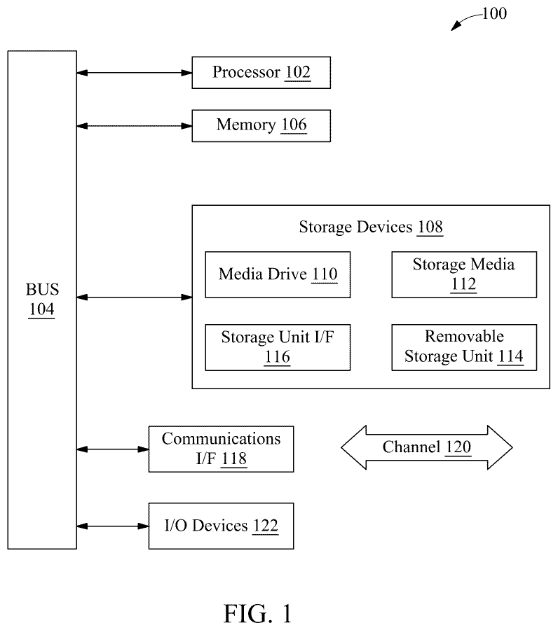

Referring now to FIG. 1, an exemplary computing system 100 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 100 may represent, for example, a user device such as a desktop, a laptop, a mobile phone, personal entertainment device, DVR, and so on, or any other type of special or general-purpose computing device as may be desirable or appropriate for a given application or environment. The computing system 100 may include one or more processors, such as a processor 102 that may be implemented using a general or special purpose processing engine such as, for example, a microprocessor, microcontroller or other control logic. In this example, the processor 102 is connected to a bus 104 or other communication medium.

The computing system 100 may also include a memory 106 (main memory), for example, Random Access Memory (RAM) or other dynamic memory, for storing information and instructions to be executed by the processor 102. The memory 106 also may be used for storing temporary variables or other intermediate information during execution of instructions to be executed by the processor 102. The computing system 100 may likewise include a read only memory (“ROM”) or other static storage device coupled to bus 104 for storing static information and instructions for the processor 102.

The computing system 100 may also include storage devices 108, which may include, for example, a media drive 110 and a removable storage interface. The media drive 110 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 112 may include, for example, a hard disk, magnetic tape, flash drive, or other fixed or removable medium that is read by and written to by the media drive 110. As these examples illustrate, the storage media 112 may include a computer-readable storage medium having stored therein particular computer software or data.

In alternative embodiments, the storage devices 108 may include other similar instrumentalities for allowing computer programs or other instructions or data to be loaded into the computing system 100. Such instrumentalities may include, for example, a removable storage unit 114 and a storage unit interface 116, such as a program cartridge and cartridge interface, a removable memory (for example, a flash memory or other removable memory module) and memory slot, and other removable storage units and interfaces that allow software and data to be transferred from the removable storage unit 114 to the computing system 100.

The computing system 100 may also include a communications interface 118. The communications interface 118 may be used to allow software and data to be transferred between the computing system 100 and external devices. Examples of the communications interface 118 may include a network interface (such as an Ethernet or other NIC card), a communications port (such as for example, a USB port, a micro USB port), Near field Communication (NFC), etc. Software and data transferred via the communications interface 118 are in the form of signals which may be electronic, electromagnetic, optical, or other signals capable of being received by the communications interface 118. These signals are provided to the communications interface 118 via a channel 120. The channel 120 may carry signals and may be implemented using a wireless medium, wire or cable, fiber optics, or other communications medium. Some examples of the channel 120 may include a phone line, a cellular phone link, an RF link, a Bluetooth link, a network interface, a local or wide area network, and other communications channels.

The computing system 100 may further include Input/Output (I/O) devices 122. Examples may include, but are not limited to a display, keypad, microphone, audio speakers, vibrating motor, LED lights, etc. The I/O devices 122 may receive input from a user and also display an output of the computation performed by the processor 102. In this document, the terms “computer program product” and “computer-readable medium” may be used generally to refer to media such as, for example, the memory 106, the storage devices 108, the removable storage unit 114, or signal(s) on the channel 120. These and other forms of computer-readable media may be involved in providing one or more sequences of one or more instructions to the processor 102 for execution. Such instructions, generally referred to as “computer program code” (which may be grouped in the form of computer programs or other groupings), when executed, enable the computing system 100 to perform features or functions of embodiments of the present invention.

In an embodiment where the elements are implemented using software, the software may be stored in a computer-readable medium and loaded into the computing system 100 using, for example, the removable storage unit 114, the media drive 110 or the communications interface 118. The control logic (in this example, software instructions or computer program code), when executed by the processor 102, causes the processor 102 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

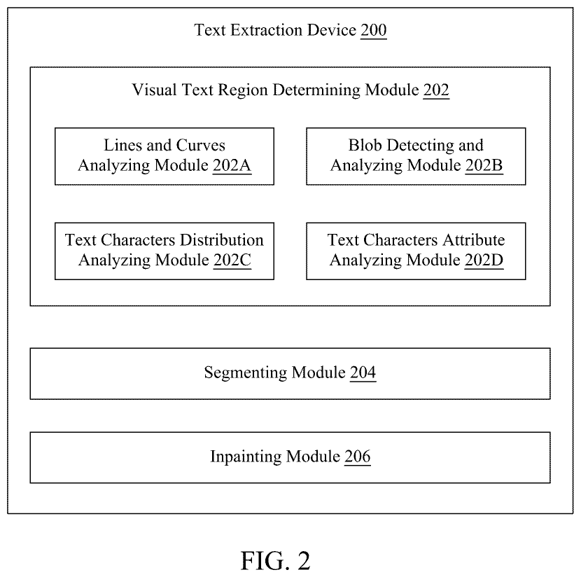

Referring now to FIG. 2, a block diagram of a text extraction device 200 for extracting text from a video stream is illustrated, in accordance with an embodiment of the present disclosure. The text extraction device 200 may include a visual text region determining module 202, a segmenting module 204, and an inpainting module 206.

As will be understood, a video stream includes a plurality of video frames. Further, a set of frames from the plurality frames may include a text, for example movie credits (which may include a role and name of a person who performed that role, e.g. the role is “Director of photography” and the name of the person is “John Smith”). It should be noted that the set of frames may be in image format (as such, the term “frame” and “image” may have been used interchangeably in this disclosure).

The text extraction device 200 is configured extract the above-mentioned text from the set of images. To this end, the visual text region determining module 202 of the text extraction device 200 may identify a set of images which include text, from the plurality of images. In other words, the visual text region determining module 202 may identify the images which include text that may be processed further to extract the text, and leave the rest of the images which do not include any text.

Once the set of images including text are identified, the visual text region determining module 202 may further determine at least one visual text region in each image. As mentioned earlier, the video stream may include the plurality of images in sequential order, and the at least one visual text region may include a plurality of text characters. For example, the plurality of text characters may include alphabets, numerical digits, special characters, etc. Further, the plurality of text characters may belong to any one or a combination of two or more scripts such as Roman script, Chinese script, Arabic script, Devanagari script, etc.

Further, it should be noted that in an image containing text, the text may be present on a part of the image and confined within a visual text region. Further, the text may be infused with background which may be acting as a part of the text. It is, therefore, desirable to accurately identify the visual text region within the image to avoid analyzing the entire image for extracting the test. By first singling out one or more visual text region within the image, only the relevant regions within image are analyzed and therefore the efficiency of the process of text extraction is improved.

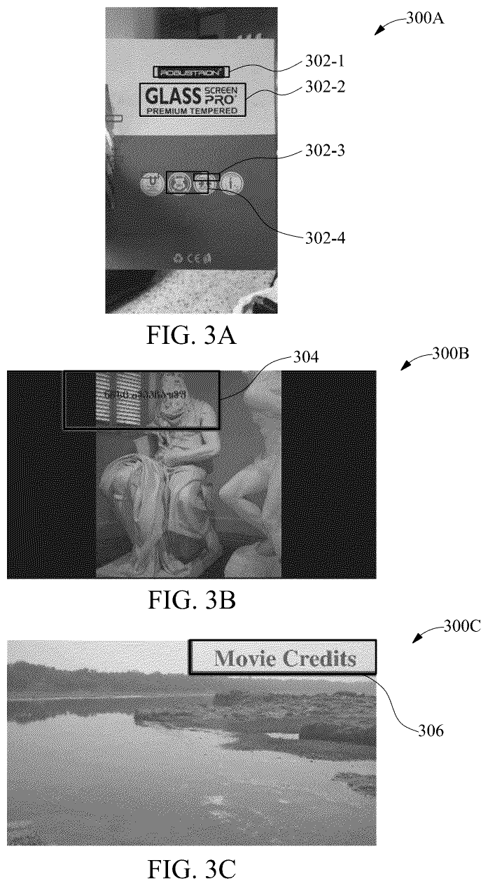

Referring now to FIGS. 3A-3C, various snapshots of example video frames comprising text are illustrated, in accordance with an embodiment. FIG. 3A illustrates a first snapshot 300A comprising multiple visual text regions 302-1, 302-2, 302-3, 302-4, as marked in rectangular boxes. As will be understood, each of the visual text regions 302-1, 302-2, 302-3, 302-4 comprises text characters in Roman (English) script. Further, as shown in FIG. 3A, the visual text regions 302-1, 302-2 are present on a background which is substantially plain and White in color. Furthermore, the visual text regions 302-3, 302-4 are present on a background which is substantially plain and Black in color. FIG. 3B illustrates a second snapshot 300B comprising a visual text region 304, as marked in a rectangular box. The visual text region 304 comprises text characters in a Brahmic script. The text characters of the text region 304 are present on a graphical background, as a result of the which these text characters are infused with background, with the background acting as a part of the text characters. FIG. 3C illustrates a third snapshot 300C comprising a visual text region 306, as marked in a rectangular box. The visual text region 306 comprises text characters in Roman (English) script, with the text characters of the text region 306 mostly being present on plain background White in color.

Referring back to FIG. 2, in some embodiments, determining the at least one visual text region is based on analysis of one of: lines and curves associated with each of the plurality of text characters of the at least one visual text region, a blob associated with the plurality of text characters along an axis, distribution of the plurality of text characters along a major axis (i.e. Horizontal axis or Vertical axis), and a common attribute associated with the plurality of text characters. To this end, in some embodiments, the visual text region determining module 202 may include a lines and curves analyzing module 202A, a blob detecting and analyzing module 202B, a text characters distribution analyzing module 202C, and a text characters attribute analyzing module 202D.

The lines and curves analyzing module 202A may analyze the lines and curves associated with each of the plurality of text characters of the at least one visual text region. It is assumed that the text in an image may possess shaper edges, since the construction of any script is by way of using lines and curves. Further, the text characters may be formed with intersection of lines and curves thereby forming corners. By way of an example, the lines and curves analyzing module 202A may analyze pixel intensity and average axial distance between these corners to estimate a visual text region. In particular, the lines and curves analyzing module 202A may detect one or more corners formed with intersection of the lines and curves associated with each of the plurality of text characters. Further, the lines and curves analyzing module 202A may determine pixel intensity and average axial distance between the one or more corners. Furthermore, the lines and curves analyzing module 202A may determine the at least one visual text region based on the pixel intensity and average axial distance. In some embodiments, an expression for detecting corners and checking axial uniformity in the possible visual text region may be as follows:

$$E ( u , υ ) = {\sum }_{x , y} {{\underbrace{w ( x , y )}}_{window function} [ {\underbrace{I ( x + u , y + υ )}}_{shifted intensity} - {\underbrace{I ( x , y )}}_{intensity} ]}^{2} \qquad Equation ( 1 )$$

$$E ( u , v ) ∼ [ u v ] {\sum }_{x , y} w ( x , y ) [ \begin{matrix}IxIx & IxIy \\ IxIy & IyIy\end{matrix} ] [ \begin{matrix}u \\ v\end{matrix} ] \qquad Equation ( 2 )$$

$$R = det ( M ) - {k ( trace ( M ) )}^{2}$$

where,
det(M)=λ1 λ2,
trace(M)=λ1+λ2,
λ2 and λ2 are the eigen values of Matrix (M)

Using the above expression, difference in intensities for a displacement of (u, v) may be calculated. It should be noted that window function may either be rectangular or gaussian window. The eigen values (λ1 and λ2) may determine whether a region is a corner, an edge, or a flat region.

The blob detecting and analyzing module 202B may identify blob(s) of gray connected stable components within the image. For example, the blob detecting and analyzing module 202B may analyze the blob associated with the plurality of text characters along an axis based on maximally stable extremal visual text regions (MSER) model. It is assumed that the text characters within the visual text region are stable connected components and distributed with respect to eight major geographical axes (i.e. the axes aligned with geographical East, West, South, North, North-East, North-West, South-East, and South-West direction). As will be appreciated by those skilled in the art, the MSER model may be used as a method of blob detection in images, based on finding correspondences between image elements from two images with different viewpoints.

The MSER features may be extracted from the images by identifying localized seed (Minima) and locating the maximum change in pixel value in multiple directions. The resultant points can be encapsulated in a rectangle. A rectangular blob region may be filtered based on histogram of height of the rectangle. The regions with consistent height may be within the configurable threshold limit. Using a set of points qualified as corners and text blobs (or MSER blobs), a gradient in x direction is determined for finding axial symmetry, as follows:

$$gradient = ∇ R ( x , y ) = \partial R / \partial x ( x , y ) \qquad Equation ( 3 )$$

From the Equation (3), it may be found that the points are at equal distance axially. Further, points having similar heights in y direction may be determined using Equation (4) and Equation (5), as below:

$$H = {lim}_{0 \to i} gradient ( {y}_{i} ) - gradient ( {y}_{i + 1} ) \qquad Equation ( 4 )$$

$$Qualified points Q = histogram ( sort ( H ) ) \qquad Equation ( 5 )$$

The text characters distribution analyzing module 202C may analyze homogenous distribution of the text along a major axis (i.e. Horizontal axis or Vertical axis). As will be understood, corners formed around the visual text may be distributed with very low gradient along the major axis. Therefore, based on the analysis of the axial gradient distribution, corner points describing the visual text region may be identified. Once the corner points are identified, the visual text region may be determined.

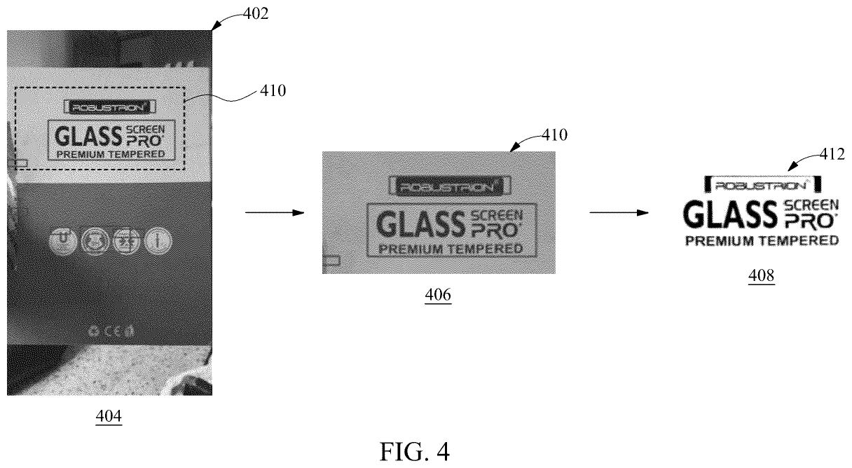

The text characters attribute analyzing module 202D may analyze the common attributes associated with the plurality of text characters. In some embodiments, the common attribute may be a font, a size, or a spacing associated with each of the plurality of text characters. It is assumed that text characters sharing common attributes are related to each other. In particular, for example, text characters which are written together (i.e., similar spacing) with same font size and color may be associated with each other. As such, for example, the text characters, i.e. alphabets of the term “Director of photography” of the above example may share common attributes in terms of font, size, or spacing. Therefore, the text characters attribute analyzing module 202D may determine a visual text region based on detection of occurrence of common attributes of the text characters. It should be noted that the text characters attribute analyzing module 202D may not necessarily identify the text characters, however, simply by analyzing the presence of the above-mentioned common attributes, the text characters attribute analyzing module 202D may be able to determine a visual text region where text is present in an image. As such, the text characters attribute analyzing module 202D may cluster pixels with symmetrically axial distribution. The above is further explained in conjunction with FIG. 4.

Referring now to FIG. 4, a process diagram of a process 400 of extracting text from a frame (image) 402 of a video stream is illustrated, in accordance with an embodiment. At step 404, a visual text region 410, as marked in a rectangular box, is determined, and at step 406, the visual text region 410 is extracted, i.e. separated from the rest of the image 402. As will be understood, the steps 404 and 406 may be performed by the visual text region determining module 202 of the text extraction device 200.

Returning back to FIG. 2, once the one visual text region is identified by the visual text region determining module 202, the segmenting module 204 may segment the plurality of text characters within the at least one visual text region from a background associated with the at least one visual text region. In some embodiments, the segmenting may be performed based on k-means clustering. In particular, the process of segmenting may include classifying each pixel associated with the at least one visual text region into a predefined category of one or more predefined categories based on pixel intensity and color. Further, the segmenting may include generating one or more clusters corresponding to the one or more predefined categories, and identifying, from the one or more clusters, a cluster corresponding to text characters distinct from clusters corresponding to background.

As will be appreciated, the visual text region may include a two-dimensional array of pixels. Further, in some instances, the text characters may be infused with the background, with the background acting as a part of the text characters. The segmenting module 204 may classify pixels associated with the text characters as distinct from the pixels associated with the background. Therefore, in order to segment, i.e. distinguish the text characters from the background, the pixels may be categorized into two or more categories, using k-means clustering. In some example embodiment, the pixels may be categorized into five categories (i.e. k=5). As will be understood, some of these categories may correspond to the text while remaining categories may correspond to the background.

Further, in some embodiments, a category associated with a pixel may be determined using averaging method. To this end, coordinates of corners of a probable visual text region may be determined. Thereafter, an average value of the coordinates may be obtained. The pixels around the coordinates of the corners may be categorized based on the average value. As such, one or more clusters of pixels corresponding to text characters may be determined. The one or more clusters corresponding to text characters may constitute the at least one visual text region. For example, as shown in FIG. 4, once the visual text region 410 is determined and extracted, text characters 412 from the visual text region 410 may be segregated, at step 408 by the segmenting module 204 of the text extraction device 200.

Referring back to FIG. 2, once the plurality of text characters within the at least one visual text region are segmented from the background, each of these plurality of text characters may be inpainted with a predefined color. By way of an example, the each of the plurality of text characters may be inpainted with Black color on white canvas (background). In particular, the pixels categorized into a category corresponding to the text characters may be inpainted with Black color. Similarly, the pixels categorized into a category corresponding to the background may be inpainted with White color. Therefore, the plurality of text characters may be inpainted with Black color while the background region may be inpainted with White color.

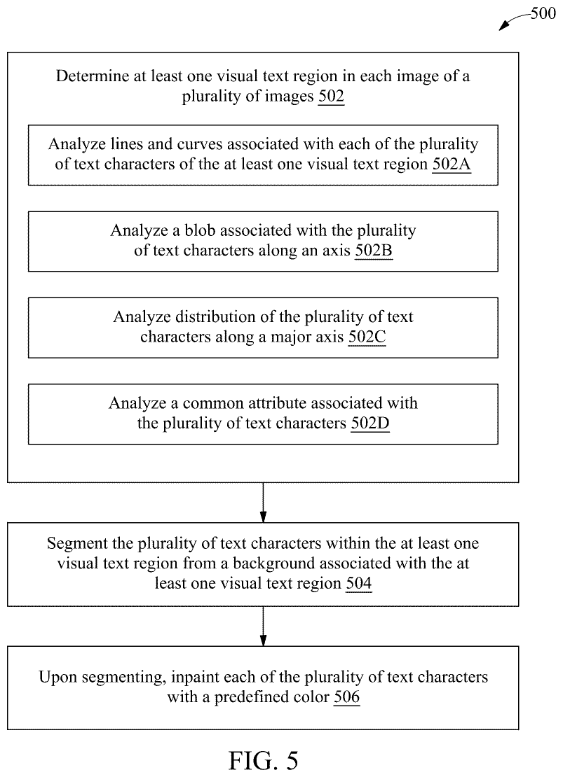

Referring now to FIG. 5, a flowchart of a method 500 of extracting text from a video stream is illustrated, in accordance with an embodiment of the present disclosure. The method 500 may be performed by the text extraction device 200. It should be noted that the method 500 may be directed to detecting a visual text region, and then estimating the background associated with the visual text regions and reconstructing the image with minimal contribution of original background. A video stream which includes a plurality of frames and from which text is to be extracted may be received by the text extraction device 200. As mentioned earlier, a set of frames from the plurality frames may include a text, for example movie credits (which may include a role and name of a person who performed that role, e.g. the role is “Director of photography” and the name of the person is “John Smith”). The method 500 may first identify the set of frames from the plurality frames that may include text.

In some embodiments, the set of images which include text may be identified from the plurality of images. Once the set of images including text are identified, at step 502, at least one visual text region from each image of a plurality of images may be determined. As will be understood, the video stream may include the plurality of images in a sequential order. The at least one visual text region may include a plurality of text characters. In some embodiments, determining the at least one visual text region may involve additional steps 502A-502D where an analysis of the images may be carried.

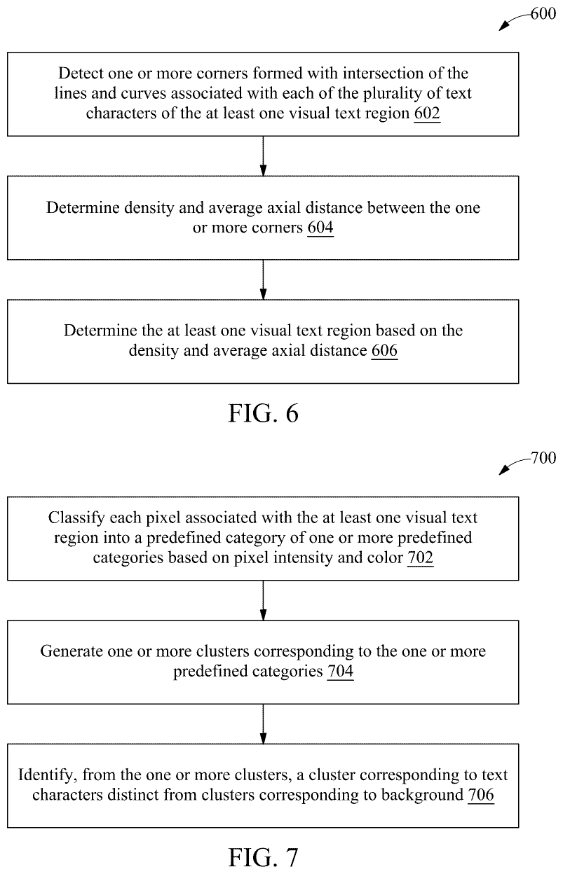

At step 502A, lines and curves associated with each of the plurality of text characters of the at least one possible visual text region may be analyzed. The step 502A is further explained in detail in conjunction with FIG. 6.

Referring now to FIG. 6, a flowchart of a method 600 of analyzing lines and curves associated with each of the plurality of text characters of the at least one possible visual text region is illustrated, in accordance with an embodiment. At step 602, one or more corners formed with intersection of the lines and curves associated with each of the plurality of text characters of the at least one visual text region may be detected. At step 604, pixel intensity and average axial distance between the one or more corners may be determined. At step 606, the at least one visual text region may be determined based on the pixel intensity and average axial distance.

Returning back to FIG. 5, at step 502B, a blob associated with the plurality of text characters along an axis may be analyzed. The blob associated with the plurality of text characters along an axis may be analyzed based on maximally stable extremal visual text regions (MSER) model. At step 502C, distribution of the plurality of text characters along a major axis (i.e. Horizontal axis or Vertical axis) may be analyzed. At step 502D, a common attribute associated with the plurality of text characters may be analyzed. The common attribute may be one of a font, a size, or a spacing associated with each of the plurality of text characters.

It should be noted that for any image, at least one of the above steps 502A-502D may be performed. In other words, in some images, it may be possible to determine the at least one visual text region by performing any one of the steps 502A-502D, while some images may require a combination of two or more of the steps 502A-502D. Furthermore, the sequence of performing the steps 502A-502D may not be restricted to any one particular sequence, and as such, the steps 502A-502D may be performed in any sequence.

At step 504, the plurality of text characters within the at least one visual text region may be segmented from a background associated with the at least one visual text region. In some embodiments, the segmenting may be based on k-means clustering. The step 504 of segmenting is further explained in detail in conjunction with FIG. 7.

Referring now to FIG. 7, a flowchart of a method 700 of segmenting the plurality of text characters within the at least one visual text region from the background associated with the at least one visual text region is illustrated, in accordance with an embodiment. At step 702, each pixel associated with the at least one visual text region may be classified into a predefined category of one or more predefined categories based on pixel intensity and color. At step 704, one or more clusters corresponding to the one or more predefined categories may be generated. At step 706, a cluster corresponding to text characters distinct from clusters corresponding to background may be identified from the one or more clusters.

Returning back to FIG. 5, at step 506, upon segmenting, each of the plurality of text characters may be inpainted with a predefined color. By way of an example, the each of the plurality of text characters may be inpainted with Black color on a White background.

The present disclosure discusses various techniques for accurately extracting visual texts from a video stream by removing complex background. The techniques provide optimized, cost effective, and one shot (i.e. with very few or no iterations required) techniques for removing the background and segmenting the text, by using clustering techniques, such as, but not limited to, K-means clustering. The above techniques are useful in media application, such as credit scenes digitization, subtitle verification, media library, metadata tagging, and the like.

It is intended that the disclosure and examples be considered as exemplary only, with a true scope and spirit of disclosed embodiments being indicated by the following claims.

What is claimed is:

1. A method of extracting text from a video stream, the method comprising:
determining at least one visual text region in each image of a plurality of images, wherein the video stream comprises the plurality of images in sequential order, wherein the at least one visual text region comprises a plurality of text characters, and wherein determining the at least one visual text region is based on analysis of one of:
lines and curves associated with each of the plurality of text characters of the at least one visual text region;
a blob associated with the plurality of text characters along an axis;
distribution of the plurality of text characters along a major axis; and
a common attribute associated with the plurality of text characters;
segmenting the plurality of text characters within the at least one visual text region from a background associated with the at least one visual text region; and
upon segmenting, inpainting each of the plurality of text characters with a predefined color.

2. The method of claim 1, wherein the analysis of lines and curves comprises:
detecting one or more corners formed with intersection of the lines and curves associated with each of the plurality of text characters of the at least one visual text region;
determining pixel intensity and average axial distance between the one or more corners; and
determining the at least one visual text region based on the pixel intensity and the average axial distance.

3. The method of claim 1, wherein the blob associated with the plurality of text characters along an axis is analyzed based on maximally stable extremal visual text regions (MSER) model.

4. The method of claim 1, wherein the common attribute is one of a font, a size, a color, or a spacing associated with each of the plurality of text characters.

5. The method of claim 2, wherein the segmenting is based on k-means clustering, and wherein the segmenting comprises:
classifying each pixel associated with the at least one visual text region into a predefined category of one or more predefined categories based on the pixel intensity and color;
generating one or more clusters corresponding to the one or more predefined categories; and
identifying, from the one or more clusters, a cluster corresponding to text characters distinct from clusters corresponding to background.

6. The method of claim 1, wherein each of the plurality of text characters is inpainted with Black color.

7. A system for extracting text from a video stream, the system comprising:
a processor; and
a memory storing a plurality of instructions, wherein the plurality of instructions, upon execution by the processor, cause the processor to:
determine at least one visual text region in each image of a plurality of images, wherein the video stream comprises the plurality of images in sequential order, wherein the at least one visual text region comprises a plurality of text characters, and wherein determining the at least one visual text region is based on analysis of one of:
lines and curves associated with each of the plurality of text characters of the at least one visual text region;
a blob associated with the plurality of text characters along an axis;
distribution of the plurality of text characters along a major axis; and
a common attribute associated with the plurality of text characters;
segment the plurality of text characters within the at least one visual text region from a background associated with the at least one visual text region; and
upon segmenting, inpaint each of the plurality of text characters with a predefined color.

8. The system of claim 7, wherein the analysis of lines and curves comprises:
detecting one or more corners formed with intersection of the lines and curves associated with each of the plurality of text characters of the at least one visual text region;
determining pixel intensity and average axial distance between the one or more corners; and
determining the at least one visual text region based on the pixel intensity and the average axial distance.

9. The system of claim 7,
wherein the blob associated with the plurality of text characters along an axis is analyzed based on maximally stable extremal visual text regions (MSER) model; and
wherein the common attribute is one of a font, a size, or a spacing associated with each of the plurality of text characters.

10. The system of claim 8, wherein the segmenting is based on k-means clustering, and wherein the segmenting comprises:
classifying each pixel associated with the at least one visual text region into a predefined category of one or more predefined categories based on the pixel intensity and color;
generate one or more clusters corresponding to the one or more predefined categories; and
identifying, from the one or more clusters, a cluster corresponding to text characters distinct from clusters corresponding to background.

11. A non-transitory computer-readable medium storing computer-executable instructions for extracting text from a video stream, the computer-executable instructions configured for:
determining at least one visual text region in each image of a plurality of images, wherein the video stream comprises the plurality of images in sequential order, wherein the at least one visual text region comprises a plurality of text characters, and wherein determining the at least one visual text region is based on analysis of one of:
lines and curves associated with each of the plurality of text characters of the at least one visual text region;
a blob associated with the plurality of text characters along an axis;
distribution of the plurality of text characters along a major axis; and
a common attribute associated with the plurality of text characters;
segmenting the plurality of text characters within the at least one visual text region from a background associated with the at least one visual text region; and
upon segmenting, inpainting each of the plurality of text characters with a predefined color.

12. The non-transitory computer-readable medium of claim 11, wherein to analyze lines and curves, the computer-executable instructions are configured for:
detecting one or more corners formed with intersection of the lines and curves associated with each of the plurality of text characters of the at least one visual text region;
determining pixel intensity and average axial distance between the one or more corners; and
determining the at least one visual text region based on the pixel intensity and the average axial distance.

13. The non-transitory computer-readable medium of claim 11, wherein the blob associated with the plurality of text characters along an axis is analyzed based on maximally stable extremal visual text regions (MSER) model.

14. The non-transitory computer-readable medium of claim 11, wherein the common attribute is one of a font, a size, a color, or a spacing associated with each of the plurality of text characters.

15. The non-transitory computer-readable medium of claim 12, wherein the segmenting is based on k-means clustering, and
wherein the computer-executable instructions are configured to perform the segmenting by:
classifying each pixel associated with the at least one visual text region into a predefined category of one or more predefined categories based on the pixel intensity and color;
generating one or more clusters corresponding to the one or more predefined categories; and
identifying, from the one or more clusters, a cluster corresponding to text characters distinct from clusters corresponding to background.

16. The non-transitory computer-readable medium of claim 11, wherein each of the plurality of text characters is in painted with Black color.
